(19) United States
(12) Patent Application Publication
(10) Pub. No.: US 2004/0089485 A1
(43) Pub. Date: May 13, 2004

(54) Vehicle drive arrangement having multiple-sized electric motors

(76) Inventors: Dennis A. Kramer, Troy, MI (US); Clive Harrup, Bromham (GB); Mehmet S. Ciray, Greenwood, IN (US); Silvio M. Yamada, Gahanna, OH (US); Dean M. House, Pataskala, OH (US); David K. Platner, Shelby, MI (US); Dale J. Eschenburg, Clinton Twp., MI (US); Dale K. Bell, Ortonville, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/290,887

(22) Filed: Nov. 8, 2002

(51) Int. Cl. B60K 1/00

(52) U.S. Cl. 180/65.1

(57) ABSTRACT

An electric motor assembly for providing driving torque to a wheel on a vehicle includes a plurality of different sized motors. The motor having the largest outside dimension or outside diameter is placed closest to the wheel hub to provide the largest possible motor size within typical vehicle packaging constraints. A plurality of motors is used to achieve a desired torque level at the wheel. In one example, multiple motors are positioned near each wheel with the size of the motors decreasing from a lateral side of the vehicle toward the centerline of the vehicle. Motor control strategies for achieving different torque levels and providing selectively regenerative effects are disclosed.

### BACKGROUND OF THE INVENTION

This invention generally relates to vehicle drives that utilize electric motors to provide a driving torque to at least one wheel. More particularly, this invention relates to an arrangement of different size electric motors for providing driving torque to at least one wheel.

Electric drives for vehicles have been proposed as primary drive sources or alternative drive sources in so-called hybrid vehicles. There are a variety of challenges presented when attempting to design such a vehicle to accommodate traditional vehicle design and to achieve adequate performance under a variety of operating conditions.

For example, it is desirable to maintain existing axle, differential carrier and drive shaft packaging envelopes when converting or supplementing an internal combustion engine-based drive train with an electrically powered propulsion arrangement. Typical heavy vehicles have a drive shaft from the main transmission connecting to the drive axle differential, which includes two output shafts associated with the drive axles connected to the wheel ends. Such arrangements have particular packaging envelopes within which components can fit.

In some vehicles it is particularly desirable to maintain a low clearance path, such as along the center of a mass transit vehicle or bus.

Such packaging constraints place limits on electric motor driving arrangements because it is desirable to use large diameter motors to produce sufficient torque. Accordingly, a strategic design and placement of electric motor components is required to provide a workable arrangement that fits within typical vehicle packaging constraints.

This invention meets that need and provides additional benefits that overcome drawbacks and shortcomings of previously proposed arrangements.

### SUMMARY OF THE INVENTION

In general terms, this invention is an electrically powered vehicle wheel drive assembly having a plurality of electric motors of different sizes with the largest motor closest to the vehicle wheel.

One vehicle drive assembly designed according to this invention includes a wheel hub and an axle associated with the wheel hub such that the wheel hub is rotatable. A plurality of electric motors having different diameters provide rotation to the wheel hub with a larger diameter motor closer to the wheel hub.

One method of electrically powering a vehicle wheel assembly that has a wheel hub space from a center line of the vehicle according to this invention includes several steps. First, different diameter electric motors are provided between the centerline of the vehicle and the wheel hub with the largest diameter motor closest to the wheel hub. The electric motors are selectively powered to achieve a desired torque at the wheel hub.

In one example arrangement, the different motors are individually powered so that a combined torque provided by the motors gives the desired driving torque to the wheel hub.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates a vehicle incorporating a drive assembly designed according to this invention.

FIG. 2 schematically illustrates an example drive assembly designed according to this invention.

FIG. 3 schematically illustrates another example.

### DETAILED DESCRIPTION OF THE PREFERRED EMBODIMENTS

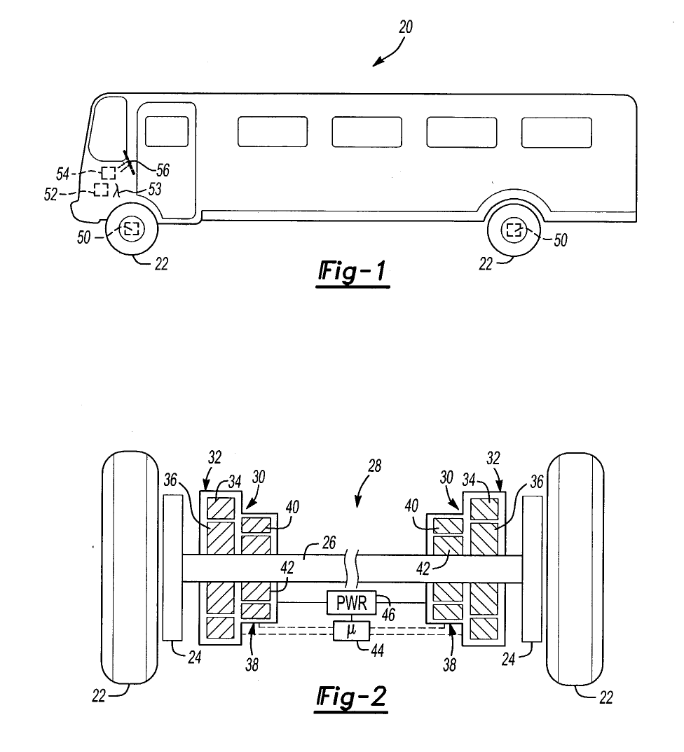

FIG. 1 schematically illustrates a vehicle 20 having a plurality of wheels 22 that are moveable for propelling the vehicle in a chosen direction at a desired speed. As can best be appreciated from FIG. 2, each wheel 22 is associated with a wheel hub 24 that is supported with a wheel axle 26 such that the wheel hub 24 and wheel 22 are rotatable relative to the vehicle 20 in a conventional manner.

An electrically powered drive assembly 28 is associated with each drive wheel hub 24. The electric motor assembly 30 includes a first electric motor 32 that includes a stator portion 34 and an armature portion 36. Another electric motor 38 is positioned adjacent the motor 32. Electric motor 38 includes a stator portion 40 and an armature portion 42. Electric motors 32 and 38 in one example operate in a generally known manner.

The electric motor 32 has a larger outside dimension or outside diameter than the motor 38. According to this invention, the larger sized electric motor 32 is positioned closer to the wheel hub 24 than the motor 38. Although only two motors 32 and 38 are illustrated in the example embodiment, more than two motors may be used. It is most preferred to have the larger diameter motors more laterally outward (i.e., closer to the wheel hub 24) than the smaller sized motors. In one example, at least three electric motors are incorporated with decreasing sizes in a direction from the outside of the vehicle toward a centerline of the vehicle.

The inventive arrangement allows for greater radial spacing of the armature and stator of the larger sized motor 32 so that larger driving torques can be achieved. Because the motor 38 is of a smaller size, it will provide less torque and for a given RPM will add less horsepower to the corresponding drive shaft for the same current and flux density as the larger sized motor 32.

An electronic controller 44 selectively controls each of the motors 32 and 38, individually. The controller 44 may be a dedicated microprocessor or a portion of a controller already on the vehicle, for example. The combined torque provided by each motor gives the desired amount of driving torque at the wheel hubs 24. Additionally, depending on the axle design 26, the motors at the opposite sides of the vehicle can be selectively controlled independently from each other so that different driving torques or wheel speeds are provided at the left and right wheels of a single axle assembly. The controller 44 is programmed in a conventional manner to operate the motors 32 and 38 from a conventional power source 46.

In one example, at least one of the motors 32 or 38 can be selectively used during deceleration or braking of the vehicle to have a regenerative effect for recharging the power source 46 as may be needed. The controller 44 preferably is suitably programmed in such an example to control the motors accordingly.

Because the motors 32 and 38 are independently operable, one may be driven in an opposite direction of the other so that the combined torque provided by the motor combination is at a desired level. Such an arrangement is useful, for example, in avoiding complicated gear reduction arrangements to achieve a desired torque at the wheel hub 24, given typical rotary speeds of electric motors.

A significant advantage of this invention is that it strategically places multiple sized electric motors along an axle assembly so that the largest diameter motor is closest to the wheel hub where the packaging envelope is generally the largest. Recognizing that there still are limitations on the size of motor that can be used, the combination of a plurality of motors provides the ability to achieve a desired driving torque while staying within given packaging constraints.

The motors selected may be any one of available electric motor devices such as DC series motors, parallel motors, compound motors, brushless motors, AC motors, synchronous motors, split phase motors, etc. The particular type of motor used for each of the motors that is best suited for a particular application will become apparent to those skilled in the art who have the benefit of this description so they can make the best choice for their particular situation.

In one example, the controller 44 controls the operation of the motors 32 and 38 depending on the driving conditions of the vehicle 20. The illustrated example includes conventional sensors such as wheel speed sensors 50, a throttle position sensor 52 associated with an accelerator pedal 53 and a steering angle sensor 54 associated with a steering arrangement 56 for the vehicle 20. In one example, the controller 44 utilizes information from each of the sensors in a known manner to determine the current vehicle operating condition such as whether the vehicle is accelerating, coasting, decelerating, braking or a combination of any two or more of those. Depending on the driving conditions, the controller 44 determines how to drive the motors 32 and 38 at the opposite sides of the vehicle to achieve maximum performance. The controller 44 also uses such information in one example in deciding when to use one or more of the motors as a regenerative source for recharging the power source 46.

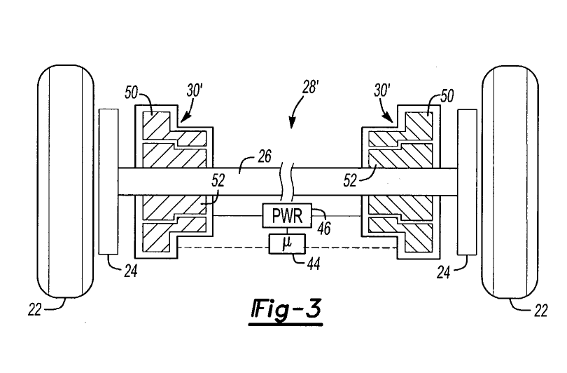

The example of FIG. 3 shows a modification compared to that in FIG. 2. In this example a single motor is provided with each wheel of the assembly. Each motor has multiple outside dimensions (i.e., diameters) with the largest outside dimension closest to the corresponding wheel.

The drive assembly 28′ includes electric motor assemblies 30′ that have a stator portion 50 and an armature portion 52. The stator portion 50 has a larger outside dimension closer to the wheel 22 compared to the part of the stator that is positioned closer to the centerline of the vehicle. The armature portion 52 has a varying dimension corresponding to the dimensions of the stator portion 50. The electric motor assemblies 30′ in this example are controllable using conventional techniques.

This invention provides a significant improvement in that typical vehicle packaging constraints can be accommodated while still providing an economical solution to achieving a desired driving torque for a variety of vehicles while avoiding a need for a relatively complicated gearing arrangement.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A vehicle drive assembly comprising:
a wheel hub;
an axle supporting the wheel hub such that the wheel hub is rotatable relative to another portion of the vehicle; and
a plurality of electric motors having different outside dimensions providing rotation to the wheel hub with a larger outside dimension motor closer to the wheel hub.

2. The assembly of claim 1, wherein the motors comprise at least one of DC series motors, parallel motors, compound motors, brushless motors, AC motors, synchronous motors, and split phase motors.

3. The assembly of claim 1, including a controller that powers each of the plurality of electric motors separately.

4. The assembly of claim 3, wherein the controller controls a first one of the motors to drive the wheel hub and a second one of the motors to generate power to recharge a power source associated with the electric motors.

5. The assembly of claim 3, wherein the controller controls a first one of the motors to provide driving torque in a first direction and a second one of the motors to provide torque in a second direction.

6. The assembly of claim 3, wherein the axle permits opposing wheel hubs to rotate at different speeds and the controller controls a first plurality of motors independent of a second plurality of motors positioned laterally opposite the first plurality.

7. The assembly of claim 6, including a steering angle sensor that provides information regarding a steering angle of the vehicle and the controller controls the first and second pluralities of motors responsive to information from the steering angle sensor.

8. The assembly of claim 3, including a throttle position and vehicle speed sensor and wherein the controller controls at least one of the motors to recharge a power source associated with the motors when the throttle position and vehicle speed sensors indicate that the vehicle is coasting.

9. An assembly for providing driving torque to a wheel that is laterally spaced from a centerline of a vehicle, comprising:
a first motor having a nominal outside dimension between the wheel and the centerline of the vehicle;
a second motor between the first motor and the wheel, the second motor having a larger outside dimension than the nominal dimension; and
a controller that controls the first and second motors independent of each other to provide desired driving torque to the wheel.

10. The assembly of claim 9, wherein the motors comprise at least one of DC series motors, parallel motors, compound motors, brushless motors, AC motors, synchronous motors, and split phase motors.

11. The assembly of claim 9, wherein the controller controls the first motor to provide driving torque in a first direction and the second motor to provide driving torque in a second direction.

12. The assembly of claim 9, including sensors that provide information regarding a vehicle operation condition and the controller selectively controls the first and second motors responsive to the information regarding the vehicle operation condition.

13. A method of powering a vehicle wheel assembly having a wheel spaced from a centerline of the vehicle, comprising the steps of:
providing at least one electric motor having different diameters between the centerline of the vehicle and the wheel with a largest diameter closest to the wheel; and
selectively powering the motor to achieve desired torque at the wheel.

14. The method of claim 13, including using multiple motors and controlling a first motor to provide torque in a first direction and controlling a second motor to provide torque in an opposite direction.

15. The method of claim 13, including determining a vehicle operation condition and controlling the motor responsive to the determined operation condition.

16. The method of claim 13, including generating recharging power using the motor at a selected time.

17. A vehicle drive assembly, comprising:
a wheel hub;
an axle supporting the wheel hub such that the wheel hub is rotatable relative to another portion of the vehicle; and
at least one electric motor having different outside dimensions providing rotation to the wheel hub with a larger outside dimension of the electric motor positioned closer to the wheel hub.

18. The assembly of claim 17, wherein the electric motor has an increasing outside dimension in a direction from a centerline of the vehicle toward the wheel hub.

19. The assembly of claim 17, wherein the electric motor includes at least two outside dimensions.
